(19) United States
(12) Patent Application Publication
(10) Pub. No.: US 2005/0053834 A1
(43) Pub. Date: Mar. 10, 2005

(54) Positive electrode material and method

(75) Inventors: Jiang Fan, San Diego, CA (US); Douglas Charles Magnuson, San Diego, CA (US)

Correspondence Address: DONN K. HARMS;PATENT & TRADEMARK LAW CENTER, SUITE 100, 12702 VIA CORTINA, DEL MAR, CA, 92014, US

(73) Assignee: Advanced Battery Technology, Ltd.

(21) Appl. No.: 10/656,677

(22) Filed: Sep. 4, 2003

(51) Int. Cl. H01M 4/62; B05D 5/12

(52) U.S. Cl. 429/217; 429/232; 252/182.1; 427/58

(57) ABSTRACT

A hydrophobic battery electrode formed of substantially hydrophobic particles and method therefor. The particles are rendered substantially hydrophobic through coating the individual particles with a comparatively hydrophobic polymer or metal. Optionally one or a combination of conductive materials and/or lithium salts may be included in the hydrophobic polymer coating to render the resulting particle both substantially hydrophobic and with one or a combination of increased ionic and electrical conductivity.

### FIELD OF THE INVENTION

The disclosed device relates to the field of batteries. More particularly it relates to the formation of the battery electrodes from an electrode formed of particles which are coated with a comparatively hydrophobic material to increase the hydrophobic properties of those particles thereby rendering them substantially hydrophobic. Also disclosed is the method increasing the hydrophobic properties of the particles forming the electrodes which form the battery electrode, and lithium ion batteries formed using this construction and method.

### BACKGROUND OF THE INVENTION

Conventional electrochemical devices such as batteries are used widely in the world as a source of portable electrical power for devices requiring direct electrical current. Such battery devices provide the electrical power for everything from watches to automobiles, and as a consequence, great value is placed on the reliability, energy density or electrical storage capacity of these devices and their continued ability to provide an adequate supply of electrical current to the communicating electrical device. Currently, lithium ion batteries are a preferred battery configuration due to the inherent ability of such cells to store and discharge a large volume of electrical energy in relation to their individual volume and weight.

Conventional construction of lithium ion batteries feature a positive and a negative electrode formed of active material of the particles forming the compound on a metal substrate. The compounds used to form these positive electrodes include one or a combination of such materials as LiMnO₂, LiCoO₂, LiNiO₂, LiV₂O₅, LiFePO₄, and various mixtures and modifications of these compounds including for example, LiNi_{0.79}Co_{0.21}O₂. The layered rock salt-type oxides and spinel oxides forming the positive electrodes are obtained by mixing a starting oxide powder containing nickel, cobalt or manganese with a lithium compound powder and then calcinating the mixture. In particular, lithium cobalt-layered rock salt-type oxides, lithium nickel-layered rock salt-type oxides, lithium manganese spinel oxides or solid solutions of particles of one or a combination thereof are known in the art and used to form the positive electrodes.

In manufacture, these positive electrode active materials in powdered form, singularly or in combination, are dispersed in a non-aqueous binder material and mixed to form a paste. The mixture is then coated on a substrate or metal plate such as aluminum, and dried to form a solid composite of the mixed materials in the proper dimension for use as a positive electrode in the final assembled battery.

Conventionally, because of the aforementioned need to separate water from the various hydrophillic particles forming the electrode, a lithium battery must be assembled in a moisture controlled dry room. This is because gas could develop should traces of water be present and interact with the particles forming the electrode causing the potential for cell damage or even an explosion in extreme cases.

Also because of the need to keep the particles forming the electrode separated from water, the binder and the solvents used to mix the particles into the paste forming the eventual electrode must be water free and in many cases are highly toxic solvents requiring special handling and disposal. Such highly toxic solvents used with the raw materials forming electrodes also inherently present a problem for storage and handling. These electrodes, once formed on a substrate, are then encased in a cell can or casing whereupon both electrodes release and absorb lithium ions during discharge and charge of the battery depending on the direction of electrical current flow.

Another vexing problem for manufacturers of conventional lithium ion cells arises from the fact that the active materials, once formed into the positive electrodes or rolled or assembled into a jellyroll type configuration, but not sealed cell, are still inherently hydrophilic. Consequently the formed electrodes, prior to their sealed engagement into a battery cell, readily absorb water from the atmosphere during transportation and storage after the initial mixing of the active materials forming the electrode. Such contamination by water absorption creates problems such as high impedance of the electrode, poor cycle life of the assembled battery cell, and gas formation inside the cell can holding the electrodes which can result in breaching of the cell can due to internal pressure.

Additionally, due to the affinity for water noted above, of the materials forming the electrodes, these materials, in addition to being processed with non-aqueous solutions, must be processed in a controlled dry environment facility which increases both the time and cost of electrode manufacture. Once formed, the electrodes have a limited shelf life due to their propensity to absorb moisture.

As is obvious, this constant problem faced by manufacturers in the formation of these electrodes from the potential of water abortion, requires manufacturers to take careful and costly steps in electrode manufacture and to provide dry or water free processing areas and manufacturing processes which limit the exposure of the materials forming the electrodes to water. Such manufacturing processes, solvents, and facility requirements, dramatically increase manufacturing costs due to facility investment, hazardous waste disposal, and the serious increase in time required to keep the electrodes from contact with the atmosphere or water in general.

Published U.S. patent application No. 2003/0003352 (Kweon) teaches a method of coating an oxide layer, on to the exterior surface of the active material of a formed positive battery electrode to protect the formed electrode. However, the inorganic oxide coatings taught by Kweon are fragile and rigid which can result in cracks that will render the material hydrophilic. The oxide coatings do not change the hydrophobic nature of the particles forming the electrode itself because the water absorption characteristics of the coatings are similar to those of the particles. Further this coating as taught is difficult and expensive to achieve with conventional process methods.

U.S. Pat. No. 6,337,132 (Kajiyama) teaches the use of a metal oxide coating and a coupling agent on the surface of the active particles. However, the coated raw materials of Kajiyama cannot be processed into electrodes using aqueous solutions. If water is used to process the material, the oxide bonds to the particle will break and the coupling agents will bond together, yielding the particles hydrophilic. Further, the coating taught by Kajiyama is difficult and expensive to achieve with current process methods.

Pending U.S. patent application Nos. 2003/0039887 and 2003/0039890 teach the coating of a formed electrode using porous metal coatings to try and enhance the performance of the electrode. These electrodes are still manufactured by the aforementioned conventional method therefor suffer all of the disadvantages described above. Such coatings must be porous so that the electrolyte can communicate into the electrode of the cell assembly. As a result, such coatings would still expose the particles in the interior of the electrode to water damage. Pending Japanese publication 2002-373643 (Kensuke) discloses a construction of a battery particle which is partially covered with a lithium ion conductive polymer. However partial covering of the exterior surface leaves voids which render the formed particle susceptible to water contamination preventing the use of aqueous solutions to make the electrodes from individual particle. Further, the conductive agent and solid electrolyte particles are not imbedded adjacent to each other in a polymer coating but are isolated from each other.

There is as such, a pressing need for a device and method for the production of a substantially hydrophobic positive battery electrode which is formed using particles which are themselves individually coated to render them substantially hydrophobic. Such an electrode, should be formed of particles having a polymer or surfacing coating substantially the entire exterior surface of each particle thereby rendering them resistant to attack by water. Such a process should allow for the use of aqueous liquids or solutions in the coating thereby resulting in ease of application, decreased manufacturing time and costs, greatly reduced cost of pollution control, and make it easier to comply with existing environmental regulations.

### SUMMARY OF THE INVENTION

The above problems, and others are overcome by the herein disclosed electrode structure and method of manufacture therefor which combine to yield an improved lithium ion battery and less time consuming and expensive manufacturing costs for such batteries. The electrode and resulting battery formed using the herein disclosed method has a longer shelf life, a shorter and less expensive manufacturing time, improved manufacturing time and costs due to eased storage and manufacturing, and improved battery cell performance overall. These benefits are accomplished using the herein disclosed process which modifies the active raw material properties of the particles forming the positive electrode from hydrophilic to substantially hydrophobic.

By changing the nature of the particles forming the electrode to that of substantially hydrophobic, the electrode and battery itself except for the electrolyte filling, can be manufactured outside of a dry room which is conventionally required for the manufacture of the positive electrodes of such cells. Also a benefit of the changed hydrophobic particles is the ability of the coated active particles to be processed with aqueous solutions or non-toxic solvents such as alcohol instead of the conventionally used highly toxic solvents. Such solvents, in addition to being toxic to workers, are pollutants and expensive to dispose of because of their toxic waste nature. Elimination of these solvents during manufacturing also makes the manufacturing process itself safer and less expensive.

The device and method herein disclosed features a number of preferred embodiments resulting in five current preferred electrode structures and two methods to achieve these improved components. In a preferred embodiment active materials are chosen from a group of active electrode materials include LiMnO₂, LiCoO₂, LiNiO₂, LiV₂O₅, LiFePO₄, and various combinations thereof such as LiNi_{0.79}Co_{0.21}O₂. The surface of the particles forming the active material used to form the electrode are coated with a comparatively hydrophobic polymer such as EPDM, PVDF, etc. making each particle used to form the eventual electrode a substantially hydrophobic structure.

In another preferred embodiment, the same active materials would be mixed and coated. Additionally, an electrically conductive additive such as aluminum, carbon, etc., would be mixed into the hydrophobic polymer coating mixture to yield electrode particles having a substantially hydrophobic structure combined with increased electrical conductivity between the particles forming the eventual electrode.

Yet another preferred embodiment of the disclosed device and method the coating would contain ionically conductive material and would start with the choosing of the active particles singularly or mixtures of active particles above. The chosen particles would then be coated with the chosen hydrophobic polymer which itself would also have one or a combination of lithium salts such as LiF, Li₂CO₃, LiNO₂, LiBF₄, LIBOB, LITFSI in the coating mixture to yield a substantially hydrophobic structure of the individual particles forming the eventual electrode with each such particle also having increased ionic conductivity.

A variant of this preferred embodiment yielding a fourth preferred embodiment of the disclosed device would include lithium salts such as one or a combination of LiF, Li₂CO₃, LiNO₂, LiBF₄, LIBOB, LITFSI on the hydrophobic coating mixture and an electrically conductive additive to thereby yield a hydrophobic structure and increased ionic as well as electrical conductivity of the individual particles forming the electrode.

In a fifth preferred embodiment of the device and method herein disclosed the particles forming the electrode could be coated with an electrical conductive coating which would render the particles and formed electrode substantially hydrophobic. This embodiment would employ a coating of a suitable conductor such as aluminum which in the current favored mode of this embodiment it would be vapor coated to the individual active particles to render them substantially hydrophobic. Using an aluminum vapor coating, the active particles would be coated on their exterior surface prior to their being used to form the electrode thereby rendering the formed electrode substantially hydrophobic in nature.

In yet another preferred embodiment the particles which form the electrode could be spray coated in a continuous process instead of mixing in the above batch process.

In addition to the above noted different methods employed to achieve the above noted preferred embodiments, the resulting substantially hydrophobic particles formed in each of the four preferred embodiments can be processed in another step into battery electrodes using heretofore unusable aqueous solutions or non-toxic solvents.

Accordingly, it is the object of this invention claimed herein to provide electrode particles and an eventual formed electrode in which the active raw material properties are changed from hydrophilic to substantially hydrophobic.

It is another object of this invention to provide methods to render the hydrophilic electrode particles used in a battery electrode to a substantially hydrophobic state.

It is still another object of this invention to provide active raw material and battery electrodes which have an increased shelf life and resulting batteries made with the same electrodes which also have increased shelf life.

It is a still further object of this invention to provide an electrode formed of hydrophobic particles and method of producing such an electrode, which yields a battery with improved performance, and safety due to a lessened danger of water interacting with the electrode.

These, and further objectives of this invention will be brought out in the following part of the specification, wherein detailed description is for the purpose of fully disclosing the invention without placing limitations thereon.

### BRIEF DESCRIPTION OF THE DRAWING FIGURES

The accompanying drawings which are incorporated in and form a part of this specification illustrate embodiments of the disclosed processing system and together with the description, serve to explain the principles of the invention.

FIG. 1 depicts the first step in the method to render electrode particles hydrophobic and shows the active particles and the polymer, dissolved in a solvent.

FIG. 2 depicts the electrode particles coated with a polymer which is swelled with solvent and has optional lithium salts and/or conductive particles.

FIG. 3 depicts the electrode particles coated with a polymer once the solvent is removed and also shows optional lithium salts and/or conductive particles adhered in the polymer.

FIG. 4 depicts the steps involved in forming the coated electrode particles into a battery electrode which also has hydrophobic properties.

FIG. 5 depicts the adherence of an electrically conductive coating to the particles to substantially the entire particle surface area, which is substantially hydrophobic such as aluminum deposited by vapor coating.

FIG. 6 depicts an alternate application of the polymer dissolved in solvent being spray coated to substantially the entire surface area of the particles.

### DETAILED DESCRIPTION OF THE PREFERRED EMBODIMENTS

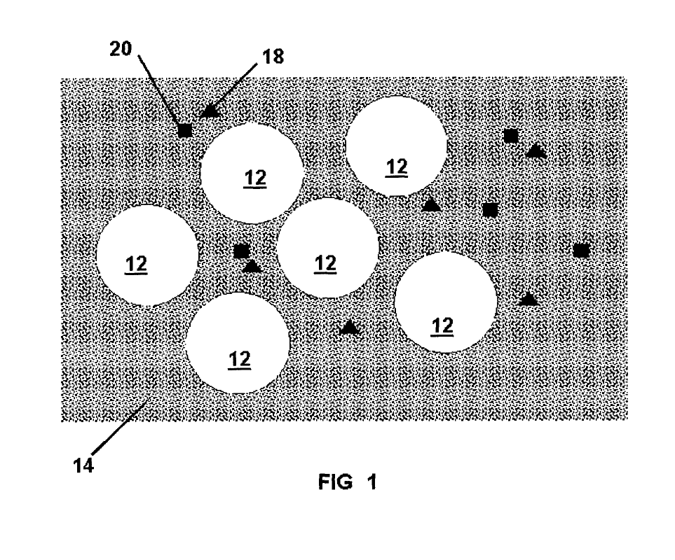

Referring now to the drawings depicting the device and method in FIGS. 1-6, FIG. 1 depicts the first step in the method to render electrode particles 12 substantially hydrophobic. As depicted the particles 12, which are later formed into the appropriately dimensioned electrode for the task, are dissolved in a solution of dissolved polymer 14 which has swelled with a suitable solvent. Also shown in the dissolved polymer 14 are the optional lithium salts 18 and conductive particles 20 which may be added to the solution depending on the desired nature of the substantially hydrophobic coating of the particles 12. In the current preferred mode of the disclosed device and method, the coating formed on the particles 12 is in the range of 0.1 to 20% of the weight of the particle with the current best mode being from 0.1% to 5%.

The particles 12 are composed of active materials suitable to the task of the eventual battery electrode they will form which in this case is lithium salts. Such active materials forming the particles 12 currently consist of one or a combination of active materials from a group of electrode materials consisting of LiMnO₂, LiCoO₂, LiNiO₂, LiV₂O₅, LiFePO₄, and LiNi_{0.79}Co_{0.21}O₂. Of course those skilled in the art will realize that active materials used for the particles which are used to form electrodes vary and change over time and with future advancements and any such variance or changes are considered within the scope of this invention. The surface of the particles 12 used to construct the active material forming the battery electrode are coated with one or a combination of polymers 14 which are inherently substantially hydrophobic, such as EPDM, PVDF. The polymers 14 are swelled with a suitable solvent during the coating process of the polymers 14 to the particles 12.

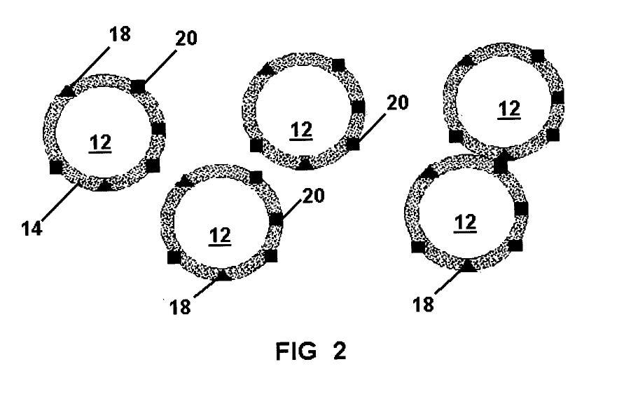

As best shown in FIG. 2, each of the particles 12 is coated with the polymer 14 which is initially swelled with a suitable solvent in which it is deposited along with the particles 12. Then the particles 12 with the swelled solution adhered to their outer surface are then allowed to dry and mild agitation can be applied to the mixture to separate the coated particles 12 from each other while they dry. As noted above, optionally, one or a combination of ionically conductive lithium salts 18 which conduct lithium ions from a group of ionic conductives including LiF, Li₂CO₃, LiNO₂, LiBF₄, LIBOB, and LITFSI, could also be deposited in the solvent with the polymer 14 and thus be included in the final substantially hydrophobic coating which dries upon and adheres to the exterior of the particle 12 which are later used to form the battery electrodes.

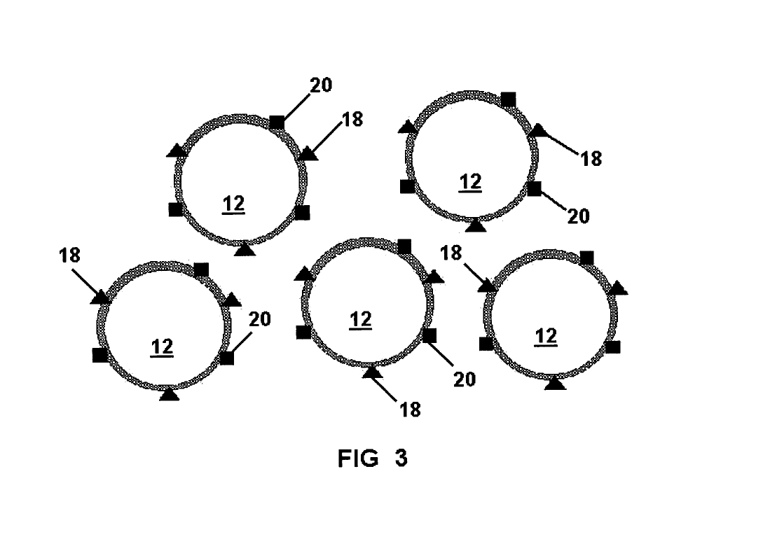

Also shown in FIGS. 1-3 is the optional addition of conductive particles 20 to the polymer 14 dissolved in the appropriate solvent. The conductive material currently favored for the conductive particles 20 currently is aluminum. The conductive particles 20 as noted may be used exclusively or in combination with the lithium salts 18 and the lithium salts 18 may be used exclusively or in combination with the conductive particles 20 during the coating process to thereby yield the substantially hydrophobic coating of the particle 12 as best depicted in FIG. 3. Of course as noted above, the polymer 14 might be used exclusively to yield the coated particles 12 making up the eventual substantially hydrophobic electrode. This finished state of the coated particle 12 showing all of the possible components of the coating, dried and coated particle 12 is shown in FIG. 3.

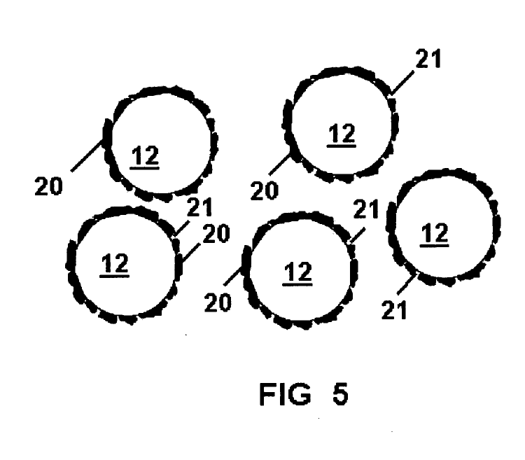

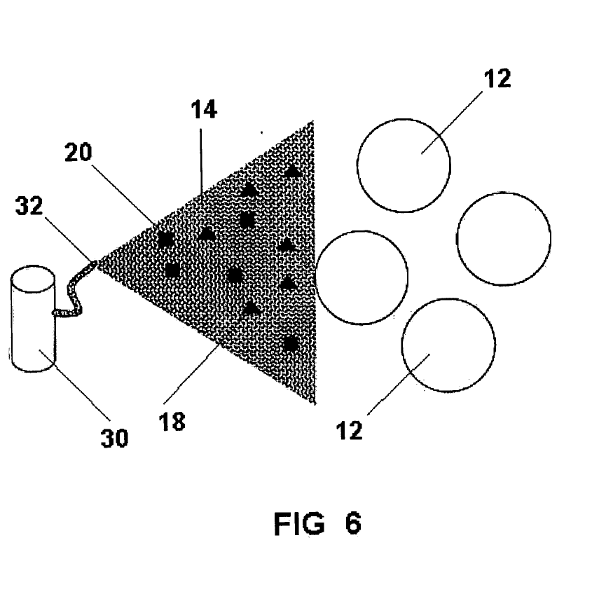

An additional preferred embodiment of the disclosed device and method herein would yield a substantially hydrophobic particle 12 to be formed into the electrode by coating substantially the entire exterior surface of the particle 12 with conductive particles 20 exclusively. In this preferred embodiment shown in FIG. 5, instead of mixing the conductive particles 20 with a polymer 14 and solvent solution, the electrically conductive particles 20 such as aluminum, would be vapor coated or spray coated to the exterior surface of the particle 12. This process is depicted in FIG. 6 where a sprayer 30 or other pressurizing means communicate the particles and any required materials through a nozzle 32 or other means to deposit the conductive particle 20 material on the exterior surfaces of the particles 12. This embodiment would strive to cover substantially the entire exterior surface of the particles 12 with the coating of electrically conductive particles 20 with minimal gaps 21 and would still yield the substantially hydrophobic coating of the surface of the particle 12 to inhibit the particle 12 from absorbing moisture and would also offer substantial electronic conductivity with adjacent particles 12 making up the eventual electrode. Minimal uncoated surface areas of the particle 21 are provided in order to maintain ionic conduction between the particles 12 which will form the battery electrode.

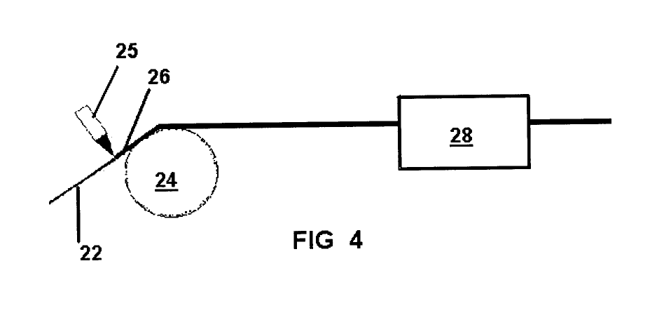

Finally, FIG. 4 graphically depicts the steps involved in forming the coated electrode particles into the eventual battery electrode which inherits the hydrophobic properties of the particles 12. As shown, an electrode would be formed by depositing the coated particles 12, each with substantially their entire exterior surface coated, upon a foil 22 or other suitable material which once coated would be communicated over rollers 24 or other means of moving the coated foil or substrate 26 to be heated in a dryer 28 to solidify the particles 12 into a formed electrode on the foil 22 which can then be wound to the proper dimensions for the intended battery.

The methods and device formed thereby, herein shown in the drawings and described in detail herein disclose steps in a process, arrangements of elements of particular construction, and configuration for illustrating preferred embodiments of structure and method of operation of the present invention. It is to be understood, however, that elements of different construction and configuration, and different steps and process procedures, and other arrangements thereof, other than those illustrated and described, may be employed for providing substantially hydrophobic electrode particles and electrodes formed thereof in accordance with the spirit of this invention.

As such, while the present invention has been described herein with reference to particular embodiments thereof, a latitude of modifications, various changes and substitutions are intended in the foregoing disclosure, and will be appreciated that in some instance some features of the invention could be employed without a corresponding use of other features, without departing from the scope of the invention as set forth in the following claims. All such changes, alternations and modifications as would occur to those skilled in the art are considered to be within the scope of this invention as broadly defined in the appended claims.

1. A substantially hydrophobic battery electrode comprising:
a plurality of particles, each of said particles having an exterior surface area;
said plurality of particles formed into an electrode;
each of said particles electrically communicating with adjacent particles forming said electrode; and
each of said particles having a coating covering substantially all of said exterior surface area, said coating comprised of coating material, said coating material being substantially hydrophobic.

2. The substantially hydrophobic battery electrode of claim 1 wherein said coating material comprises a substantially hydrophobic polymer.

3. The substantially hydrophobic battery electrode of claim 2 wherein said substantially hydrophobic polymer is comprised of one or a combination of substantially hydrophobic polymers from a group of substantially hydrophobic polymers consisting of EPDM and PVDF.

4. The substantially hydrophobic battery electrode of claim 1 additionally comprising:
said coating material also containing an electrically conductive additive.

5. The substantially hydrophobic battery electrode of claim 2 additionally comprising:
said coating material also containing an electrically conductive additive.

6. The substantially hydrophobic battery electrode of claim 3 additionally comprising:
said coating material also containing an electrically conductive additive.

7. The substantially hydrophobic battery electrode of claim 6 additionally comprising:
said electrically conductive additive being one or a combination of electrically conductive additives from a group of electrically conductive additives including aluminum and carbon.

8. The substantially hydrophobic battery electrode of claim 1 additionally comprising:
said coating material also containing ionically conductive additive therein.

9. The substantially hydrophobic battery electrode of claim 2 additionally comprising:
said coating material also containing ionically conductive additive therein.

10. The substantially hydrophobic battery electrode of claim 4 additionally comprising:
said coating material also containing ionically conductive additive therein.

11. The substantially hydrophobic battery electrode of claim 5 additionally comprising:
said coating material also containing ionically conductive additive therein.

12. The substantially hydrophobic battery electrode of claim 6 additionally comprising:
said coating material also containing ionically conductive additive therein.

13. The substantially hydrophobic battery electrode of claim 8 additionally comprising:
said ionically conductive additive being one or a combination of ionic conductives from a group of lithium salts consisting of, LiF, Li₂CO₃, LiNO₂, LiBF₄, LIBOB, and LITFSI.

14. The substantially hydrophobic battery electrode of claim 9 additionally comprising:
said tonically conductive additives being one or a combination of ionically conductive additives from a group of lithium salts consisting of LiF, Li₂CO₃, LiNO₂, LiBF₄, LIBOB, and LITFSI.

15. The substantially hydrophobic battery electrode of claim 10 additionally comprising:
said ionically conductive additives being one or a combination of ionically conductive additives from a group of lithium salts consisting of LiF, Li₂CO₃, LiNO₂, LiBF₄, LIBOB, and LITFSI.

16. The substantially hydrophobic battery electrode of claim 11 additionally comprising:
said ionically conductive additives being one or a combination of ionically conductive additives from a group of lithium salts consisting of LiF, Li₂CO₃, LiNO₂, LiBF₄, LIBOB, and LITFSI.

17. The substantially hydrophobic battery electrode of claim 12 additionally comprising:
said ionically conductive additives being one or a combination of ionically conductive additives from a group of lithium salts consisting of LiF, Li₂CO₃, LiNO₂, LiBF₄, LIBOB, and LITFSI.

18. The substantially hydrophobic battery electrode of claim 1 additionally comprising:
said coating material covering said exterior surface area being aluminum.

19. A method of rendering particles of active materials used to form a battery electrode substantially hydrophobic, comprising the steps of:
choosing active material for the formation of a battery electrode therefrom; and
coating individual particles of said active material with a substantially hydrophobic coating.

20. A method of rendering particles of active materials used to form a battery electrode substantially hydrophobic, comprising the steps of:
choosing active material for the formation of a battery electrode therefrom;
depositing individual particles of said active material in a solvent containing a substantially hydrophobic coating material;
allowing said coating material to adhere to the substantially the entire exterior surface of said individual particles; and
allowing said solvent to evaporate thereby leaving said coating material adhered to said individual particles and rendering said particles substantially hydrophobic.

21. The method of claim 19 wherein said substantially hydrophobic coating is comprised of aluminum and deposited on said particles by vapor coating.

22. The method of claim 20 additionally comprising the steps of:
mixing ionically conductive materials in said solvent; and
allowing said ionically conductive materials to adhere to said exterior surface as a component of said coating material.

23. The method of claim 22 additionally comprising the steps of:
choosing one or a combination of said tonically conductive materials to be mixed in said solvent from a group of lithium salts consisting of LiF, Li₂CO₃, LiNO₂, LiBF₄, LIBOB, and LITFSI.

24. The method of claim 20 additionally comprising the steps of:
mixing electrically conductive material in said solvent; and
allowing said electrically conductive material to adhere to said exterior surface as a component of said coating material.

25. The method of claim 22 additionally comprising the steps of:
mixing electrically conductive material in said solvent; and
allowing said electrically conductive material to adhere to said exterior surface as a component of said coating material.

26. The substantially hydrophobic battery electrode of claim 1 wherein said coating covering said exterior surface area of each of said particles has a ratio of coating weight to particle weight between 0.1% and 20%.

27. The method of rendering particles of active materials of claim 19 wherein said substantially hydrophobic coating is coated on the active particles in a ratio of coating weight to active particle weight between 0.1% and 20%.

28. The method of rendering particles of active materials of claim 19 wherein said substantially hydrophobic coating is coated on the active particles in a ratio of coating weight to active particle weight between 0.1% and 5%.

29. A method of rendering particles of active materials used to form a battery electrode substantially hydrophobic, comprising the steps of:
choosing active material for the formation of a battery electrode therefrom;
spraying the individual particles of said active material with a solvent containing a substantially hydrophobic coating material;
allowing said coating material to adhere to the exterior surface of said individual particles; and
allowing said solvent to evaporate thereby leaving said coating material adhered to said individual particles and rendering said particles substantially hydrophobic.

30. The method of claim 29 wherein said substantially hydrophobic coating material also contains one or a combination of additives from a group of additives consisting of electrically conductive additives and ionically conductive additives.

31. The method of claim 30 wherein said ionically conductive additives include one or a combination of ionically conductive additives from a group of ionically conductive additives consisting of LiF, Li₂CO₃, LiNO₂, LiBF₄, LIBOB, and LITFSI.
